(19) United States
(12) Patent Application Publication
(10) Pub. No.: US 2003/0155781 A1
(43) Pub. Date: Aug. 21, 2003

(54) French door dummy hardware

(76) Inventors: Jeanette Bui, Irvine, CA (US); Michael Winardi, Fullerton, CA (US)

Correspondence Address: Richard J. Veltman, Black & Decker Corporation, TW-199, 701 E. Joppa Road, Towson, MD, 21286, US

(21) Appl. No.: 10/079,706

(22) Filed: Feb. 20, 2002

(51) Int. Cl. E05B 15/02

(52) U.S. Cl. 292/357

(57) ABSTRACT

A dummy lockset includes a rose liner, an exterior sleeve and a retainer for retaining the sleeve on the rose liner. The exterior sleeve 14 extends through an aperture in the rose liner and is held in place by the retainer. A stop plate with a self-tightening mechanism engages the exterior sleeve to automatically align a handle coupled to the sleeve.

The present invention relates to French door dummy handles, knob, and levers and supporting hardware thereof.

### BACKGROUND OF THE INVENTION

In some installations, such as French doors, it is desirable to use a pair of locksets with one mounted on each door. At the same time, it is preferable to have one of the locksets operate the latching mechanism, with the other lockset rendered incapable of functioning.

Due to forging and manufacturing tolerances, it is difficult to fit the individual parts of a lockset together properly without costly machining. Yet, without the machining, the lockset does not fit tightly to the door, but wobbles when mounted on the door. A wobbling lockset is unacceptable to consumers, so that a mechanism is needed that provides a tight installation to reduce the likelihood of wobble without costly machining. In addition, such a mechanism should automatically ensure proper alignment of a dummy lever handle, and it should be easy to install.

### SUMMARY OF THE INVENTION

The present invention provides a stop plate incorporating self-aligning and self-tightening features that works with existing knobs and levers to eliminate wobble. The stop plate comprises means for aligning an operating handle of the lockset and means for eliminating movement between the lockset and a mounting surface. The means for aligning includes a sleeve having a slot coupled to the operating handle, and a finger configured to engage the slot. The means for eliminating includes a center section and a plurality of resilient arms extending from the center section and out of the plane of the center section.

In a preferred embodiment of the invention, the means for aligning includes a sleeve and a rose liner coupled to the operating handle, the sleeve including a slot and the rose liner including a boss, a finger configured to engage the slot, and a notch configured to engage the boss.

Other features and advantages of the invention will become apparent from the following portion of this specification and from the accompanying drawings which illustrate a presently preferred embodiment incorporating the principles of the invention.

### BRIEF DESCRIPTION OF THE DRAWINGS

FIG. 1 is an exploded view of an exterior chassis for a dummy lockset.

FIG. 2 is a plan view of an adapter used with the exterior chassis of FIG. 1.

FIG. 3 is a side view of the adapter of FIG. 2.

FIG. 4 is a perspective view of the assembled chassis with the adapter.

FIG. 5 is a section view taken through the assembled chassis and adapter of FIG. 4.

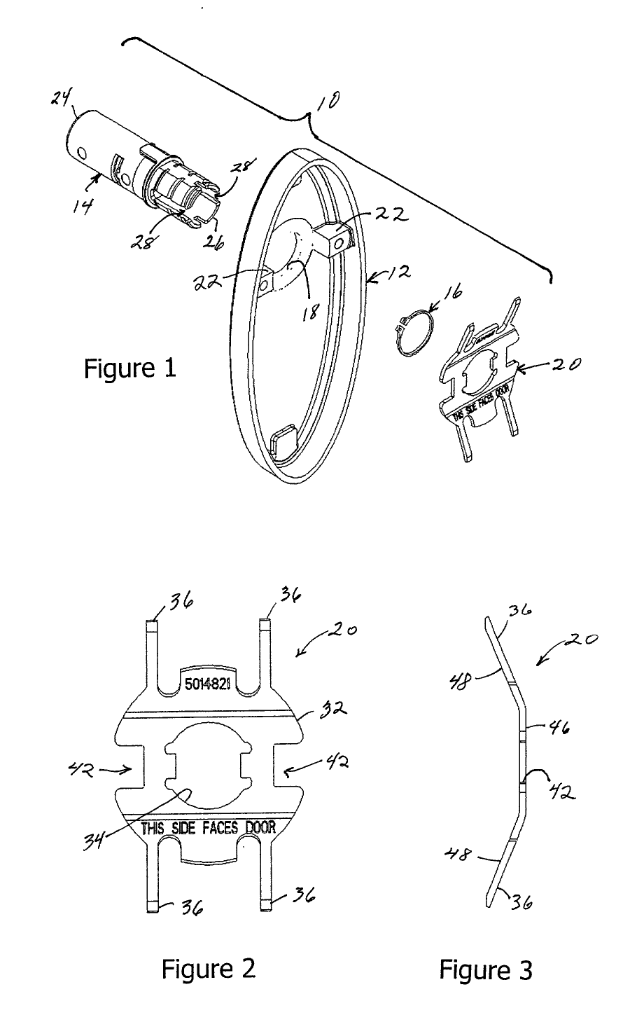

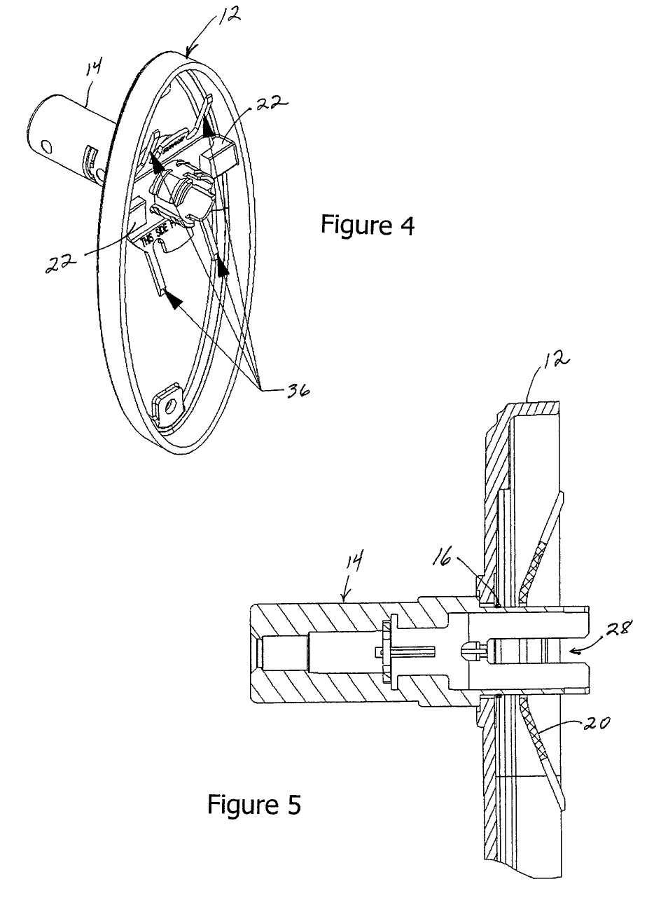

### DETAILED DESCRIPTION OF THE DRAWINGS

A dummy leverset chassis 10 includes a rose liner 12, an exterior sleeve 14 and a retainer 16. The exterior sleeve 14 extends through an aperture 18 in the rose liner 12 and is held in place by the retainer 16. A stop plate 20 with a self-tightening mechanism engages the exterior sleeve 14 and abuts the inner surface of the rose liner 12.

The rose liner 12 includes a pair of rectangular bosses 22 disposed on opposite sides of the aperture 18. The bosses 22 included threaded apertures for receiving fasteners for attaching the exterior chassis 10 to an interior chassis (not shown). The exterior sleeve 14 includes a proximal end 24 and a distal end 26. A pair of opposed longitudinal slots 28 extend from the distal end 26 toward the proximal end 24.

The stop plate 20 includes a generally circular portion 32 having a central aperture 34 and four arms 36 extending outwardly from the center portion 32. A pair of rectangular fingers 40 extends radially inwardly into the central aperture 34 and is configured to engage the slots 28 formed in the exterior sleeve 14. A pair of opposed notches 42 are formed in the circular portion 32 and are configured to engage the bosses 22 formed on the rose liner 12.

The stop plate 20 is divided into a center section 46 and two outer sections 48. The outer sections 48 are bent to extend out of the plane of the center section 46 at an angle of about 25°. When installed on the exterior sleeve 14, the center section 46 abuts the inner surface of the rose liner 12 and the outer sections 48 extend toward a mounting surface on a door.

As the rose liner 12 is pulled in toward the mounting surface during installation, the arms 36 engage the mounting surface and flex to remove any slack between the rose liner 12 and the door, providing a tight fit. At the same time, the engagement of the bosses 22 in the notches 42 prevent the stop plate 20 from rotating relative to the rose liner 12. In addition, the engagement of the fingers 40 in the slots 28 prevents the exterior sleeve 14 from rotating relative to the rose liner 12 and automatically aligns the lever handle. Thus, the stop plate 20 provides a tight and secure fit with minimum movement when installed, which is desirable for a dummy installation. In addition, the stop plate 12 is easy to install and eliminates the need for costly machining during the manufacturing process.

The above-described embodiment, of course, is not to be construed as limiting the breadth of the present invention. Modifications and other alternative constructions will be apparent which are within the spirit and scope of the invention as defined in the appended claims.

1. A stop plate for use with a dummy lockset comprising: means for aligning an operating handle of the lockset; and means for eliminating movement between the lockset and a mounting surface.

2. The stop plate of claim 1 wherein the means for aligning includes a sleeve coupled to the operating handle, the sleeve including a slot, and a finger configured to engage the slot.

3. The stop plate of claim 1 wherein the means for aligning includes a sleeve and a rose liner coupled to the operating handle, the sleeve including a slot and the rose liner including a boss, a finger configured to engage the slot, and a notch configured to engage the boss.

4. The stop plate of claim 1 wherein the means for eliminating includes a center section and a plurality of resilient arms extending from the center section and out of the plane of the center section.

5. A stop plate for use with a dummy lockset comprising: a center portion having an outer edge, a central aperture, at least one finger extending radially inwardly, and at least one notch formed in the outer edge; a pair of arms extending from the center portion and out of the plane of the center portion.

6. A lockset comprising: a rose liner having an aperture and at least one boss; a sleeve extending through the aperture and including at least one slot; a stop plate having a center aperture for receiving the sleeve, a finger extending into the center aperture for engaging the at least one slot, and a notch for engaging the at least one boss.
